(19) United States
(12) Patent Application Publication
(10) Pub. No.: US 2023/0220825 A1
(43) Pub. Date: Jul. 13, 2023

(54) INDEPENDENT WAVE ENERGY POWER GENERATION BUOYANCY TANK BASED ON PRINCIPLE OF LIQUID SLOSHING

(71) Applicant: DALIAN UNIVERSITY OF TECHNOLOGY, (US)

(72) Inventors: Chongwei ZHANG, Dalian (CN); Xunhao ZHU, Dalian (CN); Jierao DAI, Dalian (CN); Dezhi NING, Dalian (CN)

(21) Appl. No.: 17/911,344

(22) PCT Filed: Jan. 11, 2022
(86) PCT No.: PCT/CN2022/071155

§ 371 Date: Sep. 13, 2022

(51) Int. Cl. F03B 13/20

(52) U.S. Cl. CPC F03B 13/20; F05B 2220/706; F05B 2270/18

(57) ABSTRACT

The present invention provides an independent wave energy power generation buoyancy tank based on a principle of liquid sloshing. A shape of the independent wave energy power generation buoyancy tank is an oblate spherical floating sphere, and crash pads are arranged along the middle direction and the circumferential direction of the buoyancy tank. A hatch cover is installed at the top of the independent wave energy power generation buoyancy tank, and a washer is arranged at the contact between the hatch cover and the floating sphere 9. A signal lamp is installed on the hatch cover. An anchoring ring and a cable socket are installed at a top side of the independent wave energy power generation buoyancy tank. Four sand injection and discharge valves are uniformly arranged on the upper part of the independent wave energy power generation buoyancy tank along the circumferential direction.

### TECHNICAL FIELD

The present invention belongs to the technical field of ocean energy utilization, relates to an independent wave energy power generation device and particularly relates to an independent wave energy power generation buoyancy tank based on a principle of liquid sloshing.

### BACKGROUND

Offshore equipment such as distant-water fishing vessels and ocean platforms have been in production jobs for years in open seas, and the continuous operation of the equipment is accompanied by huge power consumption. The existing offshore power supply mostly uses a fuel generator. The fuel has high generation cost and large carbon emission and pollutes the environment. At the same time, equipment such as fishing vessels also has strong dependence on the continuous supply of the fuel. Offshore wave motion itself contains enormous mechanical energy. Kinetic energy and potential energy of ocean waves are extracted and converted into electrical energy to provide continuous power supply for offshore work equipment. Wave energy has high energy density, wide distribution range, less influence by sunshine and sea wind, no carbon emission, sustainability and renewability, and is an excellent supplementary source of power for the offshore equipment.

The existing wave energy power generation device (such as oscillating water column type, duck type, buoy type, pendulum type and overtopping type wave energy converters) are huge and depend on huge underwater or shore-based supporting systems, which are difficult to move or carry with the vessels. At the same time, its core machinery and electrical components used for power generation are susceptible to seawater corrosion or attachment of marine organisms, which has high requirements for repair and maintenance.

The present invention aims to provide an independent wave energy power generation device which is convenient to be carried with vessels, independent of shore-based supporting systems and free from environmental corrosion, i.e., an independent wave energy power generation buoyancy tank based on a principle of liquid sloshing. A main body of the power generation device is a closed liquid tank structure, and is small in whole volume and convenient in carrying with vessels. When power is needed, the device is dropped into the sea and made to float on the sea surface. The device moves under the action of sea wave, which stimulates liquid in a liquid tank inside the body to slosh. The sloshing liquid drives the power generation system to generate power, and then the power is transmitted to the vessel or platform through cables. A power generation tank of the device is a closed structure which is completely isolated from the marine environment to completely avoid the corrosion of the core mechanical and electrical components by seawater environment.

### SUMMARY

The purpose of the present invention is to provide an independent wave energy power generation buoyancy tank based on a principle of liquid sloshing.

The technical solution of the present invention is as follows:

An independent wave energy power generation buoyancy tank based on a principle of liquid sloshing is provided. A shape of the independent wave energy power generation buoyancy tank is an oblate spherical floating sphere 9, and crash pads 10 are arranged along the middle direction and the circumferential direction of the buoyancy tank; a hatch cover 6 is installed at the top of the independent wave energy power generation buoyancy tank, and a washer 28 is arranged at the contact between the hatch cover 6 and the floating sphere 9; a signal lamp 5 is installed on the hatch cover 6; an anchoring ring 3 and a cable socket 4 are installed at a top side of the independent wave energy power generation buoyancy tank; four sand injection and discharge valves 7 are uniformly arranged on the upper part of the independent wave energy power generation buoyancy tank along the circumferential direction.

When the independent wave energy power generation buoyancy tank is arranged, a mooring rope 8 tied to the anchoring ring 3 is used to connect the independent wave energy power generation buoyancy tank with a vessel 1, and sand is injected or discharged through the sand injection and discharge valves 7 according to the hydrological conditions of an injection site; the tonnage of the floating sphere 9 is adjusted; and the floating sphere is suspended in seawater when necessary, to achieve the purpose of safe power generation. When the independent wave energy power generation buoyancy tank is operated, the independent wave energy power generation buoyancy tank floats on the sea surface by using buoyancy generated by the floating sphere 9 and electric energy generated by the independent wave energy power generation buoyancy tank is transmitted to the vessel 1 through a shipboard cable 2 inserted in the cable socket 4.

The interior of the independent wave energy power generation buoyancy tank comprises a function cabin and a ballast tank 16; the function cabin is located in a central region in the independent wave energy power generation buoyancy tank; the ballast tank 16 is located in a region beyond the function cabin; the function cabin and the ballast tank 16 are separated by a middle longitudinal bulkhead 12; the function cabin comprises a power generation tank 14 and a liquid tank 15; the power generation tank 14 is located on an upper core region; the liquid tank 15 is located on a lower core region; the power generation tank 14 and the liquid tank 15 are separated by a middle transverse bulkhead 11; and the ballast tank 16 is equally divided into four regions by ribs 13.

The liquid tank 15 is used for placing a buoy system; the buoy system comprises a spring limiting device 19, N floating blocks 20, a slide rail 21 and a pulley 22; each floating block 20 has the same shape and size, and has a top with fan shape and a bottom with concave and convex surface; the N floating blocks 20 are uniformly distributed in the liquid tank 15 along the circumferential direction, and connected with the slide rail 21 embedded in the middle longitudinal bulkhead 12 through the pulley 22; at the same time, the spring limiting device 19 is used to limit the up and down displacement of the floating blocks 20 along the slide rail 21, and a working gap is reserved between two floating blocks 20; a lower part of each floating block 20 is immersed in liquid in the liquid tank 15, and an upper part is exposed in gas in the liquid tank 15; and the liquid contained in the liquid tank is water, and the gas contained is nitrogen or other noble gases.

The power generation tank 14 is used for placing an energy conversion system; the energy conversion system comprises a storage battery 23, a storage battery compartment 24, N linear generators 25, a wire 26 and a rectifier 27; the N linear generators 25 are uniformly distributed on a peripheral region of the middle transverse bulkhead 11 along the circumference direction, and bottoms are connected with the middle transverse bulkhead 11 by bolts; the storage battery compartment 24 is arranged in a center position of the middle transverse bulkhead 11; the storage battery 23 and the rectifier 27 are comprised in the storage battery compartment 24; bottoms of the storage battery 23 and the rectifier 27 are connected with the middle transverse bulkhead 11 by bolts; each linear generator 25 is separately connected with the rectifier 27 through the wire 26; the rectifier 27 is connected with the storage battery 23 in the storage battery compartment 24; and the storage battery 23 is respectively connected with the cable socket 4 and the signal lamp 5 through the wire 26.

The buoy system located on the liquid tank 15 is connected with the energy conversion system located on the power generation tank 14 through a transmission system; the transmission system comprises N transmission bars 17 and a waterproof flexible fabric 18; the transmission bars 17 penetrate through the middle transverse bulkhead 11 and are connected with the middle transverse bulkhead 11 by the waterproof flexible fabric 18; lower ends of the transmission bars 17 are connected with the floating blocks 20, and upper ends are connected with the linear generators 25; and one transmission bar 17 is correspondingly connected with one floating block 20 and one linear generator 25.

Further, the quantity of the floating blocks 20, the linear generators 25 and the transmission bars 17 is N≥1, and is the same.

During work, the working condition of the independent wave energy power generation buoyancy tank is as follows:

The independent wave energy power generation buoyancy tank sloshes under the action of waves in a certain direction, and then the liquid in the liquid tank 15 inside the buoyancy tank reaches resonance conditions and produces resonance motion; a liquid level fluctuates and vibrates; under the joint action of buoyancy and gravity, the floating blocks 20 vibrate up and down with the fluctuation of the liquid level; because the transmission bars 17 and a buoy 20 are fixed, the transmission bars 17 also vibrate up and down; as the transmission bars 17 vibrate up and down, the linear generators 25 connected therewith generate power; alternating current produced by the linear generators 25 enters the rectifier 27 through the wire 26, becomes direct current after rectification and is stored in the storage battery 23 through the wire 26; and part of the electrical energy stored in the storage battery 23 is used for the work of the signal lamp 5, and the other part is used to supply electrical energy for the vessel 1 through the shipboard cable 2 inserted into the cable socket 4.

The present invention has the following beneficial effects:

(1) The overall volume is small, which is convenient to carry and arrange vessels and can achieve independent power generation or array power generation.

(2) An external socket is arranged on the buoyancy tank, which can achieve fast charging for the vessels after use.

(3) A closed liquid tank is used, and the liquid tank is filled with nitrogen or other inert gas, thereby avoiding the direct contact of the floating blocks with seawater and oxygen and effectively reducing the damage of eroding the floating system by seawater.

(4) N (N≥1) floating blocks are annularly distributed in the liquid tank so that the independent wave energy power generation buoyancy tank can absorb wave energy in any direction.

(5) The buoyancy tank collects the wave energy outside the buoyancy tank into the liquid tank through the liquid tank and uses the residual energy captured inside the tank to generate power, thereby reducing the loss of the wave energy to a certain extent.

(6) The buoyancy tank is provided with the ballast tank, and the sand can be injected and discharged according to the hydrological conditions of a launching site, to complete floating and diving, which can ensure the safety and stability of offshore power generation and charging.

(7) The buoyancy tank is simple in structure and relatively convenient in installation and maintenance, which reduces the cost of a marine wave energy power generation device to a certain extent.

### DESCRIPTION OF DRAWINGS

FIG. 1 is an external view of an independent wave energy power generation buoyancy tank based on a principle of liquid sloshing; (a) is a front view, and (b) is a top view.

FIG. 2 is a launching work diagram of an independent wave energy power generation buoyancy tank based on a principle of liquid sloshing.

FIG. 3 is a functional area diagram inside the buoyancy tank; (a) is a front profile view; (b) is a top profile view at a power generation tank; (c) is a top profile view at a liquid tank.

FIG. 4 is a structural diagram of a buoy system and part of a transmission system; (a) is a profile view, and (b) is a top view.

FIG. 5 is a structural diagram of an energy conversion system and part of a transmission system; (a) is a profile view, and (b) is a top view.

FIG. 6 is a circuit diagram of an independent wave energy power generation buoyancy tank based on a principle of liquid sloshing.

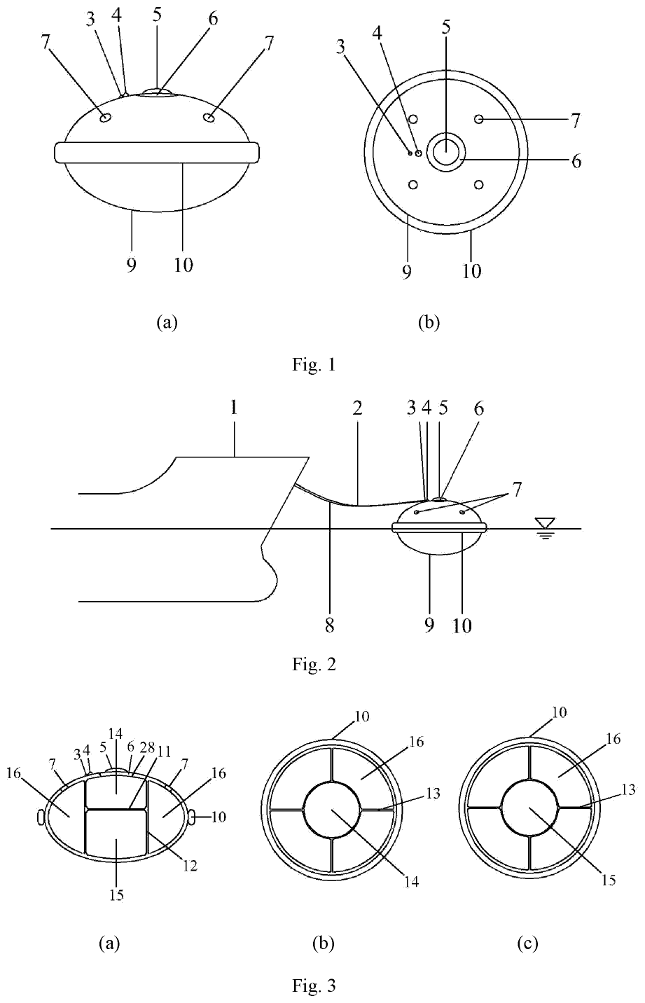

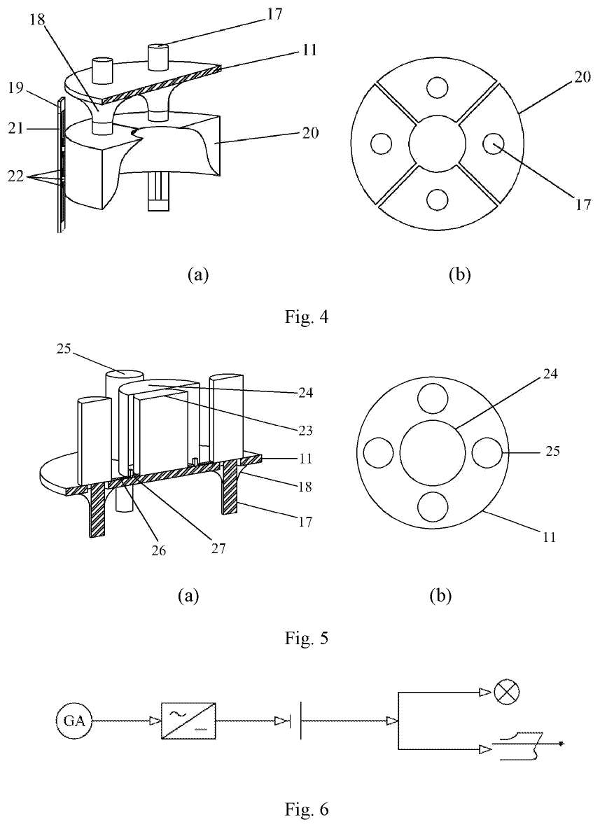

In the figures: 1 vessel; 2 shipboard cable; 3 anchoring ring; 4 cable socket; 5 signal lamp; 6 hatch cover; 7 sand injection and discharge valve; 8 mooring rope; 9 floating sphere; 10 crash pad; 11 middle transverse bulkhead; 12 middle longitudinal bulkhead; 13 rib; 14 power generation tank; 15 liquid tank; 16 ballast tank; 17 transmission bar; 18 waterproof flexible fabric; 19 spring limiting device; 20 floating block; 21 slide rail; 22 pulley; 23 storage battery; 24 storage battery compartment; 25 linear generator; 26 wire; 27 rectifier; 28 washer.

### DETAILED DESCRIPTION

The present invention is further described below in detail in combination with the drawings and specific embodiments.

An independent wave energy power generation buoyancy tank based on a principle of liquid sloshing takes floating spheres 9 as own structure, and an anchoring ring 3, a cable socket 4, a signal lamp 5, a hatch cover 6, sand injection and discharge valves 7 and crash pads 10 are arranged outside the buoyancy tank. When the buoyancy tank is arranged, a mooring rope 8 is used to connect the buoyancy tank with a vessel 1, and sand is injected or discharged through the sand injection and discharge valves 7 to control the tonnage. When the buoyancy tank is operated, electric energy is transmitted to the vessel 1 through a shipboard cable 2 inserted in the cable socket 4.

The interior of the buoyancy tank comprises a function cabin and a ballast tank 16, and the function cabin comprises a liquid tank 15 and a power generation tank 14. A buoy system is arranged in the liquid tank 15; the buoy system comprises a spring limiting device 19, floating blocks 20, a slide rail 21 and a pulley 22; an energy conversion system is arranged in the power generation tank 14; and the energy conversion system comprises a storage battery 23, a storage battery compartment 24, linear generators 25, a wire 26 and a rectifier 27. In addition, a transmission system is connected with the buoy system and the energy conversion system; and the transmission system comprises transmission bars 17 and a waterproof flexible fabric 18.

When the buoyancy tank is operated, the buoyancy tank sloshes under the action of the waves, to drive liquid in the internal liquid tank 15 to slosh, so that a liquid level in the liquid tank 15 fluctuates up and down. The floating blocks 20 vibrate up and down with the fluctuation of the liquid level. Vibration is transmitted to the linear generators 25 along with the transmission bars 17, to convert mechanical energy into electric energy. Alternating current produced by the linear generators 25 is rectified by the rectifier 27 and is stored in the storage battery 23. When the shipboard cable 2 is inserted into the cable socket 4, a discharge function is started to supply electrical energy for the vessel 1.

The product design of the present invention should fully consider the following factors:

(1) According to the wave features of different sea areas, the quantity N of the floating blocks is designed reasonably.

(2) According to the wave features of different sea areas, the height of the transmission bars, i.e., a distance between the floating blocks and bulkheads, is reasonably designed.

(3) Only the floating spheres of the buoyancy tank directly contact the seawater, so anti-corrosion work of the outer walls of the floating spheres shall be done well.

(4) To achieve the purpose of safe power generation and transmission, the volume of the ballast tank shall be reasonably designed according to the volume of the floating spheres.

The construction and installation processes of the independent wave energy power generation buoyancy tank based on the principle of liquid sloshing are as follows: (1) the floating spheres, buoy structures (the quantity of the floating blocks is determined according to actual conditions), a middle longitudinal bulkhead, a middle transverse bulkhead and ribs are constructed for subsequent installation. (2) The transmission bars and the waterproof flexible fabric of the transmission system are constructed. (3) The linear generators of the energy conversion system, the storage battery, the rectifier and the wire are constructed. (4) The signal lamp, the hatch cover, the crash pads and other modules are constructed for subsequent assembly. (5) The slide rail is embedded in an I-shaped groove reserved in the middle longitudinal bulkhead; the slide rail is fixed with the outer walls of the floating blocks by bolts; the floating blocks are connected with wheels by bolts; and then, the wheels slide into the slide rail to complete the installation of the liquid tank. (6) The linear generators, the storage battery and the rectifier are fixed on the middle transverse bulkhead by bolts to complete the installation of the power generation tank. (7) The transmission bars are connected with the floating blocks and the linear generators; the waterproof flexible fabric is installed; and finally the middle transverse bulkhead is spliced with the middle longitudinal bulkhead to complete the installation of the transmission system. (8) The ribs are spliced with the middle longitudinal bulkhead and the floating spheres to complete the installation of the ballast tank. (9) The cable socket, the sand injection and discharge valves, the signal lamp, the anchoring ring, the hatch cover, the crash pads and the washer are installed. At this point, the installation is completed.

The specific parameters of an embodiment are as follows:

The buoyancy tank shall be designed according to an actual sea state so that the internal liquid is in a resonance state as much as possible to improve the wave energy utilization ratio.

A wave environment with a wave height of 0.2 m is taken as an example. The height of the floating spheres can be 1 m, floating sphere radius is 0.75 m, and floating sphere thickness is 0.02 m; the height of the power generation tank is 0.30 m, and the radius of the power generation tank is 0.5 m; the radius of the middle transverse bulkhead is 0.5 m, and the thicknesses of the middle transverse bulkhead and the middle longitudinal bulkhead are 0.16 m; the thickness of the ribs is 0.16 mm; the height of the transmission bars below the bulkheads is 0.2 m, and the radius of the transmission bars is 0.05 m; the height of the liquid tank is 0.5 m; the thickness at which the slide rail is embedded into the inner walls of the floating spheres is 0.03 m; the connection between the wheels of the slide rail and the floating blocks protrudes by 0.01 m; and the buoy has an outer diameter of 0.44 m and an inner diameter of 0.1 m.

The floating spheres 9 adopt anti-corrosion and antifouling claddings, and water is selected as the liquid in the liquid tank. Nitrogen or other inert gas is selected as the gas.

1. An independent wave energy power generation buoyancy tank based on a principle of liquid sloshing, wherein a shape of the independent wave energy power generation buoyancy tank is an oblate spherical floating sphere (9), and crash pads (10) are arranged along the middle direction and the circumferential direction of the buoyancy tank; a hatch cover (6) is installed at the top of the independent wave energy power generation buoyancy tank, and a washer (28) is arranged at the contact between the hatch cover (6) and the floating sphere (9); a signal lamp (5) is installed on the hatch cover (6); an anchoring ring (3) and a cable socket (4) are installed at a top side of the independent wave energy power generation buoyancy tank; four sand injection and discharge valves (7) are uniformly arranged on the upper part of the independent wave energy power generation buoyancy tank along the circumferential direction;
the interior of the independent wave energy power generation buoyancy tank comprises a function cabin and a ballast tank (16); the function cabin is located in a central region in the independent wave energy power generation buoyancy tank; the ballast tank (16) is located in a region beyond the function cabin; the function cabin and the ballast tank (16) are separated by a middle longitudinal bulkhead (12); the function cabin comprises a power generation tank (14) and a liquid tank (15); the power generation tank (14) is located on an upper core region; the liquid tank (15) is located on a lower core region; the power generation tank (14) and the liquid tank (15) are separated by a middle transverse bulkhead (11); and the ballast tank (16) is equally divided into four regions by ribs (13);
the liquid tank (15) is used for placing a buoy system; the buoy system comprises a spring limiting device (19), N floating blocks (20), a slide rail (21) and a pulley (22); each floating block (20) has the same shape and size, and has a top with fan shape and a bottom with concave and convex surface; the N floating blocks (20) are uniformly distributed in the liquid tank (15) along the circumferential direction, and connected with the slide rail (21) embedded in the middle longitudinal bulkhead (12) through the pulley (22); at the same time, the spring limiting device (19) is used to limit the up and down displacement of the floating blocks (20) along the slide rail (21), and a working gap is reserved between two floating blocks (20); a lower part of each floating block (20) is immersed in liquid in the liquid tank (15), and an upper part is exposed in gas in the liquid tank (15);
the power generation tank (14) is used for placing an energy conversion system; the energy conversion system comprises a storage battery (23), a storage battery compartment (24), N linear generators (25), a wire (26) and a rectifier (27); the N linear generators (25) are uniformly distributed on a peripheral region of the middle transverse bulkhead (11) along the circumference direction, and bottoms are connected with the middle transverse bulkhead (11) by bolts; the storage battery compartment (24) is arranged in a center position of the middle transverse bulkhead (11); the storage battery (23) and the rectifier (27) are comprised in the storage battery compartment (24); bottoms of the storage battery (23) and the rectifier (27) are connected with the middle transverse bulkhead (11) by bolts; each linear generator (25) is separately connected with the rectifier (27) through the wire (26); the rectifier (27) is connected with the storage battery (23) in the storage battery compartment (24); and the storage battery (23) is respectively connected with the cable socket (4) and the signal lamp (5) through the wire (26);
the buoy system located on the liquid tank (15) is connected with the energy conversion system located on the power generation tank (14) through a transmission system; the transmission system comprises N transmission bars (17) and a waterproof flexible fabric (18); the transmission bars (17) penetrate through the middle transverse bulkhead(11) and are connected with the middle transverse bulkhead (11) by the waterproof flexible fabric (18); lower ends of the transmission bars (17) are connected with the floating blocks (20), and upper ends are connected with the linear generators (25); and one transmission bar (17) is correspondingly connected with one floating block (20) and one linear generator (25).

2. The independent wave energy power generation buoyancy tank according to claim 1, wherein the quantity of the floating blocks (20), the linear generators (25) and the transmission bars (17) is N≥1, and is the same.
